(19) United States
(12) Patent Application Publication
(10) Pub. No.: US 2026/0366381 A1
(43) Pub. Date: Nov. 19, 2026

(54) A LATCH MECHANISM FOR A FEMALE CONNECTOR OF A SUBSEA ASSEMBLY

(71) Applicant: S3N VENTUS LTD, Ashington, Northumberland (GB)

(72) Inventors: Richard PATTISON, Ashington, Northumberland (GB); Michael STANTON, Ashington, Northumberland (GB); Paul GROVES, Ashington, Northumberland (GB)

(73) Assignee: S3N VENTUS LTD, Ashington, Northumberland (GB)

(21) Appl. No.: 19/135,831

(22) PCT Filed: Dec. 11, 2023
(86) PCT No.: PCT/GB2023/053184

§ 371 Date: Jun. 5, 2025

(30) Foreign Application Priority Data
Dec. 9, 2022 (GB) 2218536.7

(51) Int. Cl. E21B 17/046; E21B 17/08

(52) U.S. Cl. CPC E21B 17/046; E21B 17/085

(57) ABSTRACT

The present invention provides for a female connector for a subsea connector assembly comprising at least one latch mechanism operably mounted into an aperture though the tubular wall along a wall axis that is aligned downward convergingly with a central axis. The latch mechanism comprises a latch member, coupled to a distal end portion of a link member so as to form a latch coupling that is configured to allow relative movement between said latch member and said link member in at least one first degree of freedom (DOF), an actuator, configured to move the coupled latch and link member from a first position to a second position, and a biasing member, configured to biasingly engage the latch member towards the first position when moving between the first position and the second position. The latch member is configured to disengage from the biasing member at the first position and move away unbiased from the first position to a third position into a central passage.

### TECHNICAL FIELD OF INVENTION

The present invention relates generally to the field of subsea tubulars and manifolds, and more particularly, to the field of subsea tubular connections or flexible umbilicals to a fixed structure including devices for limiting the bend of the flexible tubulars or umbilicals. In particular, the present invention relates to an improved latch mechanism for a female connector of a subsea connector assembly adapted for intervention-less installation of marine equipment such as, for example, a bend-stiffener for cables connecting Floating Offshore Wind (FOW) facilities.

### BACKGROUND

In subsea operations, it is often required to use a string of tubulars, also called ‘riser’, to connect equipment on the seafloor with a fixed structure above, such as, for example, an offshore floating platform (e.g. FOW) or a vessel. The string of tubulars or riser may include conduits or a plurality of conduits used for safe transport of material or subsea cables (e.g. solid, multi copper core cables for electrical connections between a renewable energy generators, such as, wind turbines of a Wind farm). The string of tubulars or risers may also comprise cabling or control lines so as to allow remote control of any equipment from the surface structure (i.e. the platform or vessel).

FIG. 1 shows an example of a typical setup for subsea operation, which could be production fluid that is transferred from at least one subsea well 10 to a floating production, storage and offloading unit 20, also referred to as FPSO 20, or a power cable 97 connecting wind turbines 95 of an FOW. In this prior art example, a flexible riser 30 (string of tubulars) is used to transports the production fluid from the well 10, or a seabed production field in case of multiple wells, to the FPSO 20 via turret 40 installed on the FPSO 20, or a cable 97 connecting the wind turbines 95. In order to protect the flexible riser 30 or cable 97 from excessive cyclic bending, for example, due to movement that may be caused by waves, current or wind, or which may simply be caused by the movement of the FPSO 20, one or more bend stiffeners 50 (only one connection is shown in FIG. 1) are typically used at the junction where the flexible riser 30 enters the fixed structure (i.e. through an ‘I’- or ‘J’ tube 60).

Often, the bend stiffener 50 is installed to the ‘I’- or ‘J’-tube 60 via a releasable connector assembly 70. The releasable connector assembly 70 may comprises a male connector member 72 that is fitted to the bend stiffener 50, and a female connector member 74 that is fitted to the ‘I’- or ‘J’-tube 60. During installation, the male connector member 72 is attached to the bend stiffener 50 and an end-fitting 32 of the riser 30 is located within and attached to the male connector member 72. In particular, the end-fitting 32 of the riser 30 is moved through the bend stiffener 50 into the throughbore of the male connector member 72 and locked into place by, for example, a cam device, a simple clamp mechanism 78, a latch mechanism or any other suitable interlocking mechanisms (not shown). The end-fitting 32 of the string of tubulars 30 is typically installed to the male connector member 72 in a workshop.

The assembly (i.e. riser 30, end-fitting 32, bend stiffener 50 and male connector member 72) is then transported to a desired subsea location and pulled towards and into connection with the female connector member 74 using a wire line 80 that is attached to the end-fitting 32 of the riser 30. Once the male connector member 72 is correctly positioned within the female connector member 74, it is retainingly interlocked with the female connector member 74, forming a secure connection between the bend stiffener 50 and the ‘I’ or ‘J’ tube 60. After locking the male connector member 72 inside the female connector member 74, the end-fitting 32 is released from engagement with the male connector portion 72 and the riser 30 is drawn up and through the bend stiffener 50 and the ‘I’- or ‘J’-tube to be fixed into place at the FPSO 20 or FOW.

Often, the locking and unlocking of the male and female connector members 72, 74, as well as, the release of the riser end-fitting 32 from engagement with the male connector member 72 is done through external intervention, such as, for example, subsea divers 90 or Remotely Operated Vehicles (ROV's) 92. In order to at least minimise the time and/or costs, as well as potential risks when using subsea divers 90 or ROV's 92 (using hydraulics), currently available connector assemblies have since been improved to also use remotely operable latch-mechanisms and/or end-fitting release mechanisms, e.g. through hydraulic or pneumatic systems controlled from topside of the FOW facility.

The releasable coupling between the male connector member and the female connector member is typically realised using pivoting latch arms (see latch arm 76 in FIG. 1) that are mounted to the female connector member and which are configured to contactingly engage with a lip or shoulder portion of the male connector member, so that the male connector member is ‘hanging’ from the radially inwardly projecting latch arms.

However, for this type of coupling engagement, any relative movement between the male connector member and the female connector member can impose substantial stress onto the latch arms, as well as, the engaging lip or shoulder portion of the male connector member. In particular, any axial dislocation between the male connector member and the female connector member, when engaged, may ‘rock’ the lip or shoulder portion up and down when sitting on respective latch arms, thus, repeatedly hammering the latch arms up to the point of potential failure. Further, currently available latch mechanisms may allow for small relative movement between the male connector member and the female connector member (e.g. caused by movement of the floating structure, wave or wind movement transmitted to the string of tubulars, or even the pressurised fluid pumped through the conduit(s)), but at the cost of an increased risk of damage due to fatigue and wear from recurring high pressures, shear stresses, imbalanced engagement and/or continuous movement between contacting surfaces between the male and female connector member.

Accordingly, it is an object of the present invention to provide a female connector for a subsea connector assembly including an improved latch mechanism adapted to compensate for the effects of unavoidable relative movement between the female connector and a coupled male connector. In particular, it is an object of the present invention to provide a female connector with a latch mechanism adapted optimise the coupling engagement between the female connector and the male connector so as to minimise potentially damaging stresses and pressures caused by relative movement between the female connector and a coupled male connector, thus, improving durability and reducing potential costs for repairs or replacement.

### SUMMARY OF THE INVENTION

Aspects of the invention are set out in the independent claim(s). Dependent claims describe optional features.

According to an aspect of the invention, there is provided a female connector for a subsea connector assembly comprising a connector body, having a tubular wall forming a central passage along a central axis, and at least one latch mechanism, operably mounted into an aperture though said tubular wall along a wall axis aligned downward convergingly with said central axis, said latch mechanism comprising:
a latch member, coupled to a distal end portion of a link member so as to form a latch coupling that is configured to allow relative movement between said latch member and said link member in at least one first degree of freedom (DOF), said coupled latch and link member being arranged jointly slidably movably at least partially within said aperture and configured to move between a first position, where said latch member is at least partially extended into said central aperture, and a second position, where said latch member is retracted out of said central passage into said aperture;
an actuator, fixedly mounted to an outer surface of said tubular wall and operably coupled to said link member, configured to move said coupled latch and link member from said first position to said second position;
a biasing member, operably coupled between said connector body and said latch member, configured to biasingly engage said latch member towards said first position when moving between said first position and said second position, wherein said latch member is configured to disengage from said biasing member at said first position and move away unbiased from said first position to a third position into said central passage.

The latch mechanism of the present invention provides the advantage of a latch that is angled downwardly such that the vertical load of the downwardly moving male connector secures itself radially centred within the female connector's central passage, while minimising forces acting between the male connector and the latch and female connector. Further, the permitted movement of the latch member (biased and unbiased) provides the advantage of an optimised engagement between the male and female connector (via the latch) irrespective of any movement of the male connector with in the central passage of the female connector. The movement of the male connector may be caused by wave movement or movement of the topside platform or vessel due to wind that is transmitted through the fixed structure or the riser, thus, causing potentially harmful shear load and moment load onto the latch and female connector. However, the latch members of the present invention are configured so as to allow small relative movement relative to the female connector in at least one DOF, i.e. sliding axially into and out of the central passage, and preferably in two DOFs, i.e. sliding movement, as well as, rotational movement about its coupling pin with the link member. The biased and unbiased DOFs allow the latch member(s) to “follow” the movement of the male connector and “correct” its position, so as to maintain its optimal contact engagement with the male connector and prevent unwanted impact forces (e.g. from a “rocking” male connector) or excessive wear (e.g. from contact surfaces sliding relative to each other). Further, the permitted unbiased movement of the latch member between its first position and its third position prevent the latches from extending too far into the central passage during installation of the male connector, i.e. when the male connector is pulled up through the central passage to then be dropped onto the latches for engagement. When the male connector is pulled up, it is advantageous to have a bit more room within the central passage, wherein upon engagement the latch members are pulled out fully to maximise the contact between the lip of the male connector and the latch members.

Advantageously, said latch coupling is formed by at least one elongated slot provided at said distal end portion of said link member and aligned parallel to said wall axis, and that is slidably and rotatably engaged with a respective latch projection, extending laterally away from said latch member along a lateral axis aligned perpendicular to said wall axis, when in situ.

Advantageously, said at least one first DOF is a sliding movement along said wall axis, when in situ. Preferably, said latch coupling is further configured to allow relative movement between said latch member and said link member in at least one second DOF. Even more preferably, said at least one second DOF is rotational movement about said lateral axis.

Advantageously, said relative movement in said first DOF is limited to the slidable range of said latch projection within said elongated slot.

Advantageously, said third position is defined by a distal end of said elongated slot when said link member is in said second position.

Advantageously, said latch mechanism further comprises a stop member, provided between said biasing member and said latch member, arranged axially slidably within said aperture and adapted to stoppingly engage with an aperture shoulder portion. Preferably, said aperture shoulder portion is provided within said aperture such that said latch member disengages from said biasing member when at said first position.

Advantageously, said wall axis is aligned downward, when in situ, converging with said centre axis at an aperture angle in the range of 25 degrees to 45 degrees. Preferably, said aperture angle is 35 degrees.

Advantageously, said actuator is adapted to retain said coupled latch and link member in said second position. Preferably, said actuator is configured to be actuated remotely.

Advantageously, said latch member comprises a support portion at a distal end configured to stoppingly engage with a male connector. Preferably, said latch member comprises a contact surface at said distal end aligned substantially parallel to said central axis, when in situ, configured to contactingly engage with an outer surface of the male connector.

Preferably, the female comprises a plurality of latch mechanisms mounted circumferentially equidistantly about said central axis into respective coplanar apertures through said tubular wall.

Advantageously, said link member comprises a handle provided at a proximal end portion, configured to allow manual movement of said coupled latch and link member from said first position towards said second position.

### BRIEF DESCRIPTION OF THE DRAWINGS

An exemplary embodiment of the invention is explained in more detail hereinbelow with reference to the figures:

FIG. 1 shows a simplified illustration of a typical offshore setup for producing hydrocarbons from a subsea well and transferring the fluids to and from a FPSO via a flexible riser, wherein the riser is protected by a bend stiffener at the point of entering an ‘I’-‘J’-tube of the FPSO;

FIG. 2 shows a perspective top view of the male- and female connector of the present invention (a) male- and female connector are axially separated, and (b) the male connector is coupled within the female connector;

FIG. 3 shows a cross-sectional side view of the tubular body of the female connector;

FIG. 4 shows (a) a partial view of the female connector and one latch mechanism coupled to the side wall and (b) a cross sectional view of the latch mechanism;

FIG. 5 illustrates (a) a cross-sectional side view of the female connector of FIG. 2 along A-A and (b) a perspective close-up view of the latch mechanism of the cross-sectional side view in (a);

FIG. 6 shows a close-up view of (a) the aperture through the tubular body of the female connector and an exploded stop member, and (b) a close up view of the aperture with inserted stop member and spring (without any other latch components;

FIG. 7 shows perspective views of (a) the latch, (b) the link member and (c) the latch coupling of the link member and the latch;

FIG. 8 shows perspective views of (a) the pneumatic or hydraulic actuator, (b) the coil spring (c) the stop member, (d) an assembly of the actuator, spring and stop member, in situ, and (e) the latch assembly;

FIG. 9 shows (a) a side view and (b) a perspective view of the latch assembly in its second position;

FIG. 10 shows (a) a side view and (b) a perspective view of the latch assembly in its first position;

FIG. 11 shows (a) a side view and (b) a perspective view of the latch assembly in its third (unbiased) position;

FIG. 12 shows a side view of the latch assembly with the latch retracted manually via a handle portion of the link member;

FIG. 13 shows a sequence (a) to (d) of the coupling process between the male connector and the female connector;

FIG. 14 shows (a) a perspective view and (b) a top view of three circumferentially equidistantly spaced latch mechanism (without the female connector component for illustrative purpose) contactingly engaged with the lip portion of the male connector, and

FIG. 15 (a) to (k) shows a full sequence of the coupling and decoupling between a male connector, with attached bend stiffener and engaged string of tubulars, and a female connector.

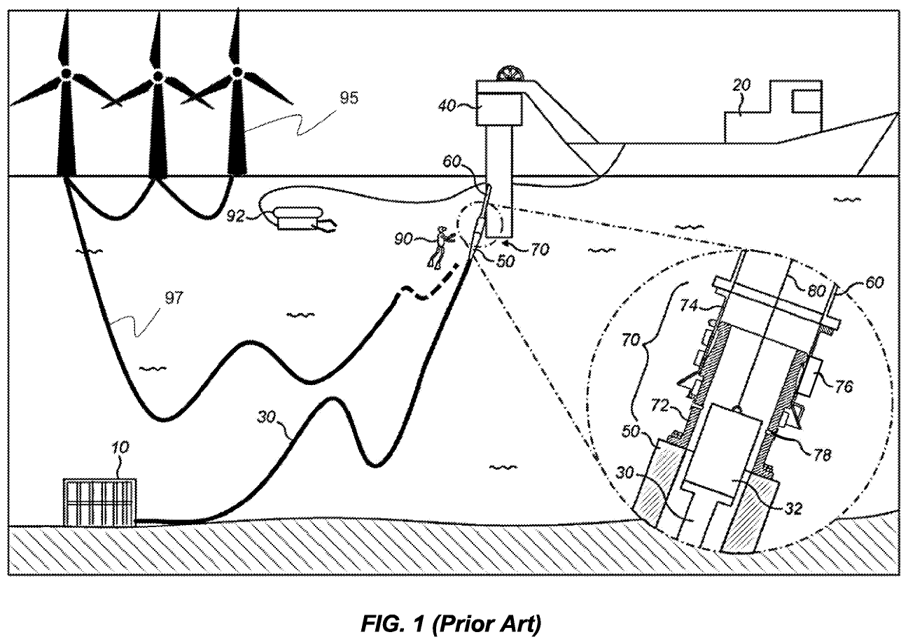

### DETAILED DESCRIPTION

The described example embodiment relates to a latch mechanism for a female connector of a subsea connector assembly, for example, a Bend Stiffener for protecting cabling of a FOW (Floating Offshore Wind system). However, the invention is not limited to offshore applications and may be used for any other suitable application.

Certain terminology is used in the following description for convenience only and is not limiting. The words ‘right’, ‘left’, ‘lower’, ‘upper’, ‘front’, ‘rear’, ‘upward’, ‘down’, ‘downward’, ‘above’, ‘below’, ‘uphole’ and ‘downhole’ designate directions in the drawings to which reference is made and are with respect to the described component when assembled and mounted (e.g. in situ). In particular, the designated directions used in the description are with respect to the equipment installed within the arrangement so as to provide a connection between the FPSO and the subsea well/reservoir. In particular, the terms ‘top’, ‘upper’ and ‘uphole’ refer to the side of the equipment directed towards the surface when in situ, the terms ‘bottom’, ‘lower’ and ‘downhole’ refer to the side of the equipment directed towards the seabed or seafloor when in situ. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Also, in this specification the term ‘latching dog’ or ‘dog’ may be understood to mean a mechanical device suitable for holding, gripping and/or fastening, comprising a spike, bar, hook, deadbolt, pin or the like. The term ‘bend stiffener’ may refer to any one of a bend-stiffener, -restrictor or -limiter. The terms ‘fixed structure’, ‘turret’, ‘I-tube’ and ‘J-tube’ may be used interchangeably. A ‘riser’ is understood to mean any string of tubulars or umbilicals suitable to operatively connect the subsea well or any other seafloor equipment with the fixed structure, e.g. a FPSO vessel. The term ‘interventionless’ is understood to mean without intervention from an ROV, subsea divers or any other device operated subsea to install the equipment. The terms ‘connector assembly’/‘connector’ and ‘adapter assembly’/‘adapter’/‘adapter ring’ may be used interchangeably.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

Through the description and claims of this specification, the terms ‘comprise’ and ‘contain’, and variations thereof, are interpreted to mean ‘including but not limited to’, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality, as well as, singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

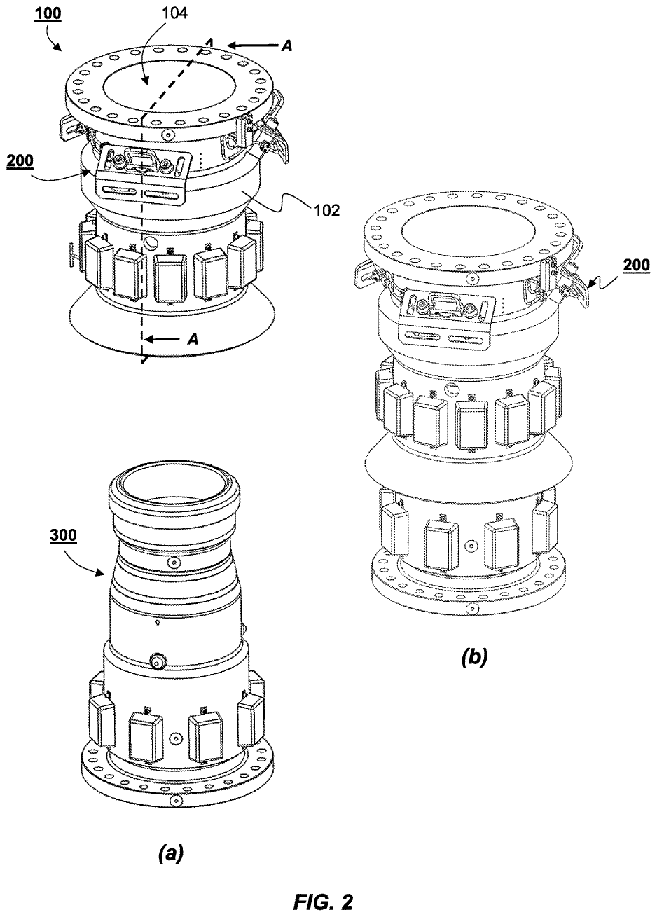

Referring now to FIG. 2, a subsea connector assembly is shown comprising a female connector 100 and male connector 300. The male connector 200 is suitably configured for coupling with the female connector 100 (see FIG. 2(b)) of the present invention. As described in the introduction section, a bend stiffener (not shown) or the like is typically attached (e.g. using screws) to the male connector 300, and the male connector 300 is pulled via an end-fitting of the string of tubulars into coupling engagement with the female connector 100 using a wire (not shown). For simplicity, the end-fitting and the wire connected to the end-fitting, which are essential to the coupling procedure, are not shown in the Figures.

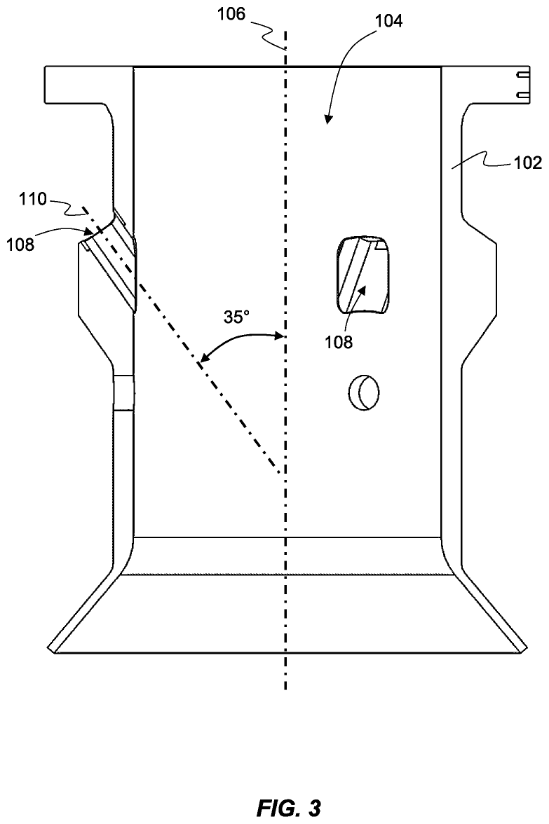

As shown in FIGS. 2 and 3, the female connector 100 comprises a tubular body 102 forming a central passage 104 or through hole along its central axis 106. Three latch mechanisms 200 are mounted to a proximal end portion of the female connector 100. In this particular example, the three latch mechanisms 200 are circumferentially equidistantly spaced apart and aligned coplanar and coaxially (with central axis 106) to each other. However, it is understood by the person skilled in the art, that the female connector 100 may be provided with any number of latch mechanisms 200 arranged in any order and formation suitable to operably engage with a male connector 300.

A respective aperture or throughbore 108 through the external wall 112 of the tubular body 102 is provided is provided for each one of the latch mechanism 200. Each one of the respective apertures 108 is extending along an aperture axis 110 through to the central passage 104 of the female connector 100, and is aligned downwards (i.e. towards the distal end of the female connector 100) and converges with the central axis 106 of the tubular body 102. The angle between the aperture axis 110 and the central axis 106 has been optimised for contact engagement with the male connector 300 and is in the range of 30° to 40° (angular degrees), preferably around 35°.

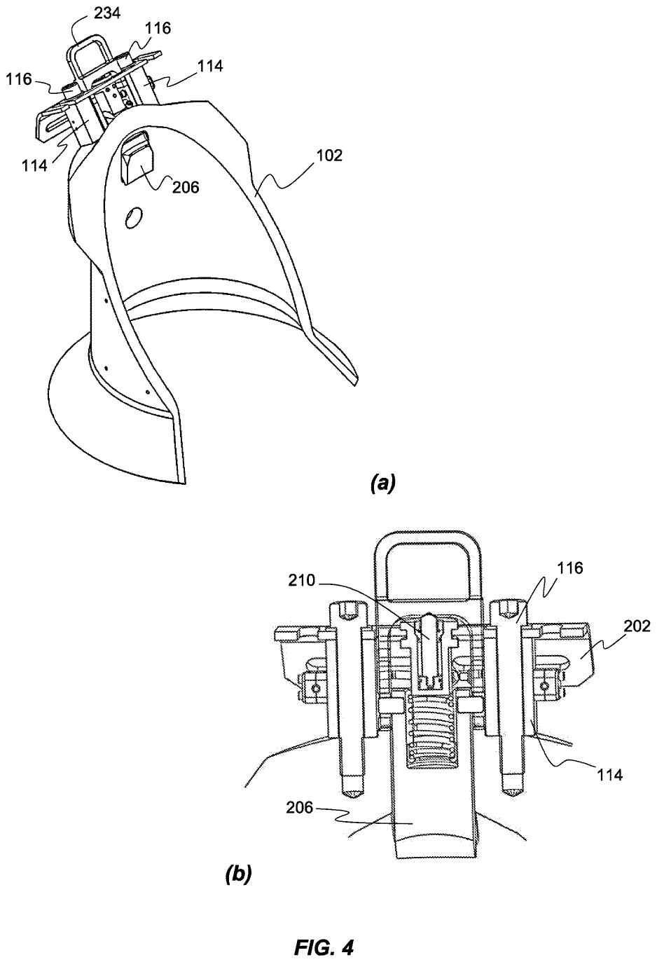

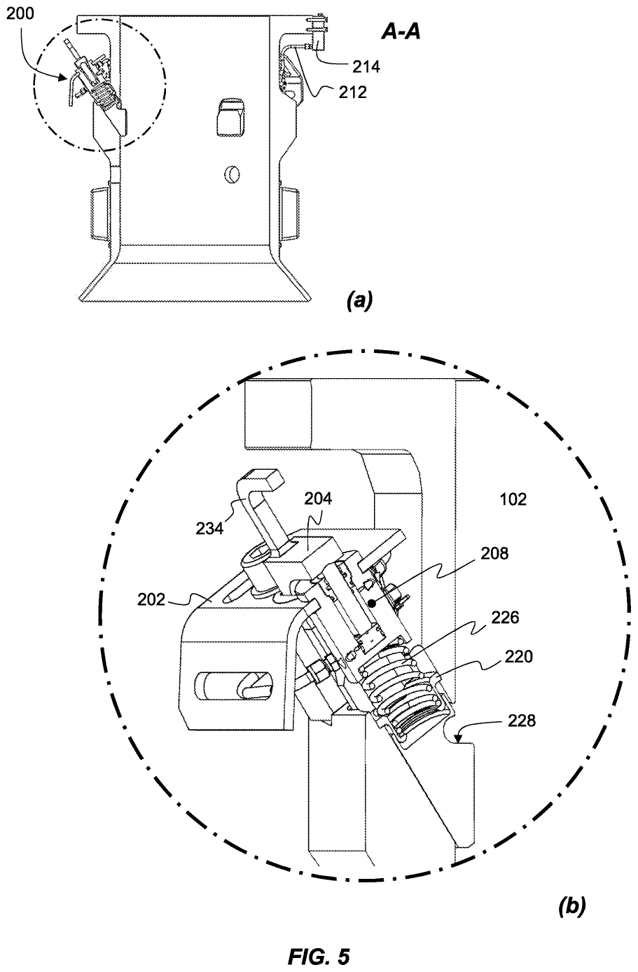

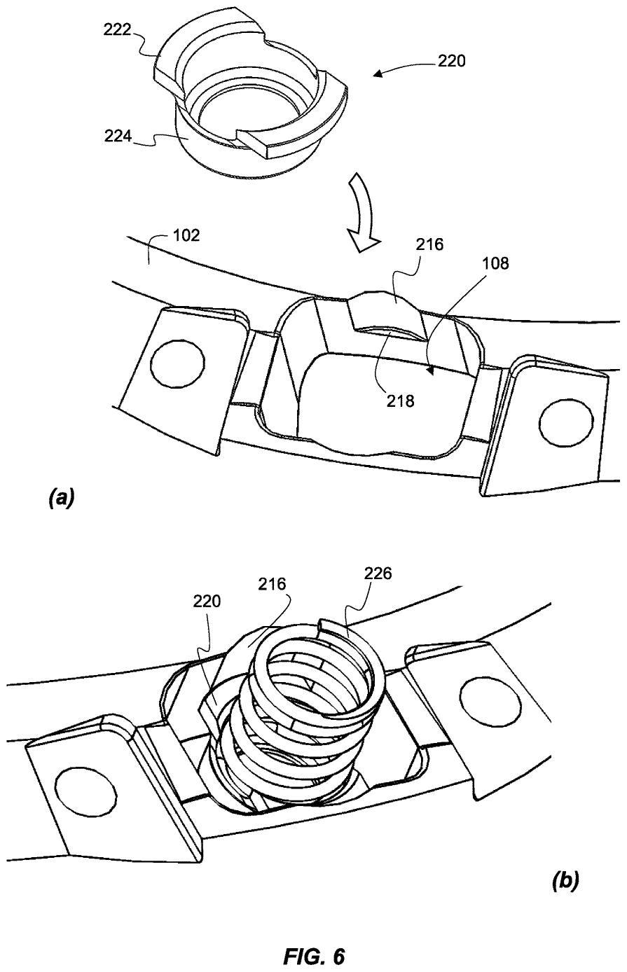

As shown in FIGS. 4 and 5, each one of the latch mechanisms 200 is mounted to the external wall 112 via two parallelly arranged latch mounts 114 that are fastened to the external wall 112 of the tubular body 102 via respective bolts 116. A latch mounting plate 202 is fixed between the two latch mounts 116 via the bolts 116. The latch mounting plate 202 is configured to operably house the latch assembly, comprising of a link member 204 operably coupled with a latch 206, a pneumatic or hydraulic actuator 208, a spring 226 and stop member 220 (see also FIGS. 6, 7, 8).

When assembled, in situ, the link member 204 and coupled latch 206 are mounted slidably movable relative to the latch mounting plate 202 and within the aperture 108. The actuator 208 is immovably fixed to the latch mounting plate 202, centrally between the two latch mounts 114 so as to allow its piston rod 210 to engage with the link member 204. When actuated, the piston rod 210 is adapted to push the link member 204, as well as, the coupled latch 206 from a first position, where the latch 206 is protruding into the central passage 104, to a second position, where the latch 206 is retracted back into the aperture 108 (i.e. is not protruding into the central passage 104). The piston rod 210 may be retracted back into the actuator cylinder 208 through the coil spring 226 pushing the latch 206 back towards its first position.

The actuator 208 of the present embodiment is controlled via pneumatic or hydraulic fluid lines or conduits 212 that arranged to connect respective actuators 208 with a control manifold 214 that is mounted at the proximal end of the female connector 100.

FIGS. 6(a) and (b) shows a detailed view of the aperture 108 further comprising two radially opposing guide slots 216 extending from the aperture's proximal opening to a predetermined axial length within the aperture 108, thus forming respective shoulder portions 218 separating a larger diameter opening at the aperture's proximal end portion and a smaller diameter opening at the aperture's distal end portion. The location of the shoulder portion 218 within the aperture 108 may be at any suitable distance from the external wall 112 so as to provide sufficient axially unbiased movement of the latch 206. A stop member 220 shaped so as to slidably movably fit into the aperture 108 is provided within the aperture 108. The stop member 220 has a rim portion 222 at its proximal end and a cup portion 224 at its distal end. The rim portion 222 is dimensioned, so as to fit into the larger diameter opening of the aperture 108 and to stoppingly engage with respective shoulder portions 218. The cup portion 224 is dimensioned to slidably fit into the smaller diameter opening of the aperture 108 and to house the coil spring 226.

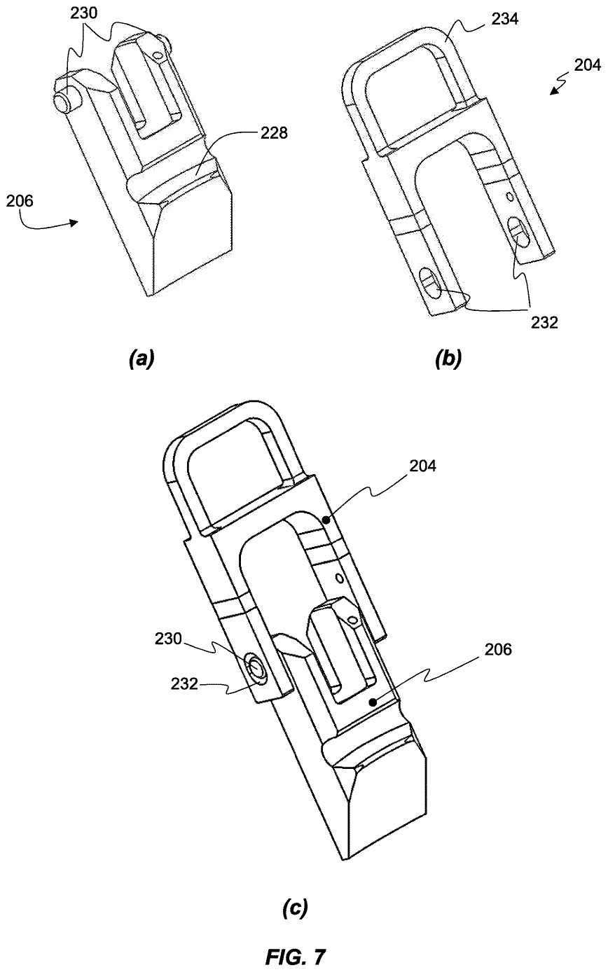

As shown in FIG. 7, the latch 206 is adapted to slidingly fit into the aperture 108 having a seat portion 228 configured for contact engagement with a lip of the male connector 300, during use. Two laterally protruding pins 230 are provided at the proximal end of the latch 206 for coupling with the link member 204. The link member 204 comprises a U-shaped body having two parallel arms, each one provided with an elongated pin aperture 232 at its distal end. The elongated pin aperture 232 is adapted to operably receive the pins 230 allowing limited axial movement (along aperture axis 110, in situ), as well as, rotational movement between the coupled link member 204 and latch 206. A handle portion 234 is provided at a proximal end portion of the link member 204 for manual actuation of the latch 206.

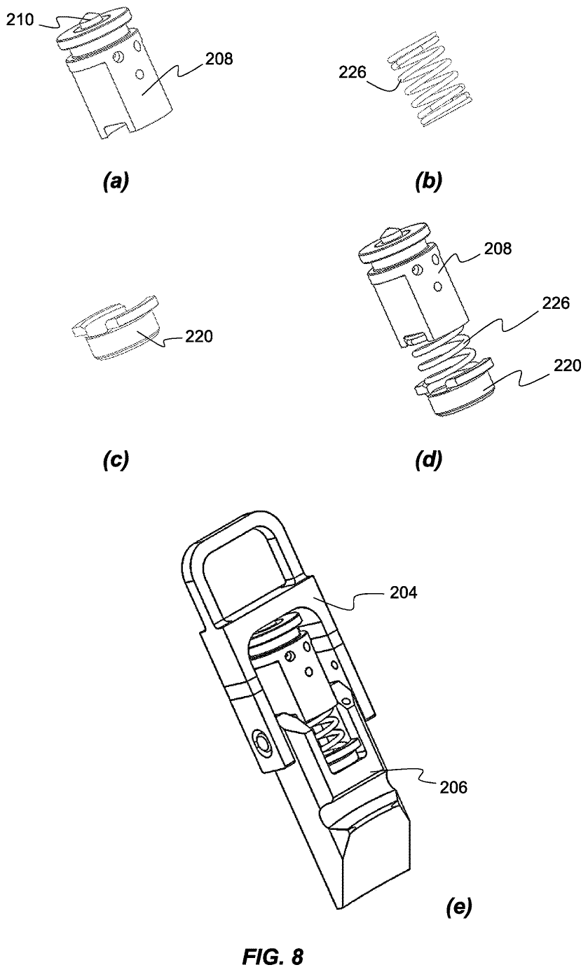

FIG. 8 (a) to (e) shows detailed views of the actuator 208, coil spring 226 and stop member 220, as well as, the components assembly. During use, the components are arranged within the coupled link member 204 and latch 206, so as to provide a biasing force between the immovably fixed actuator 208 and the latch 206 (coupled with the link member 204) via the stop member 220.

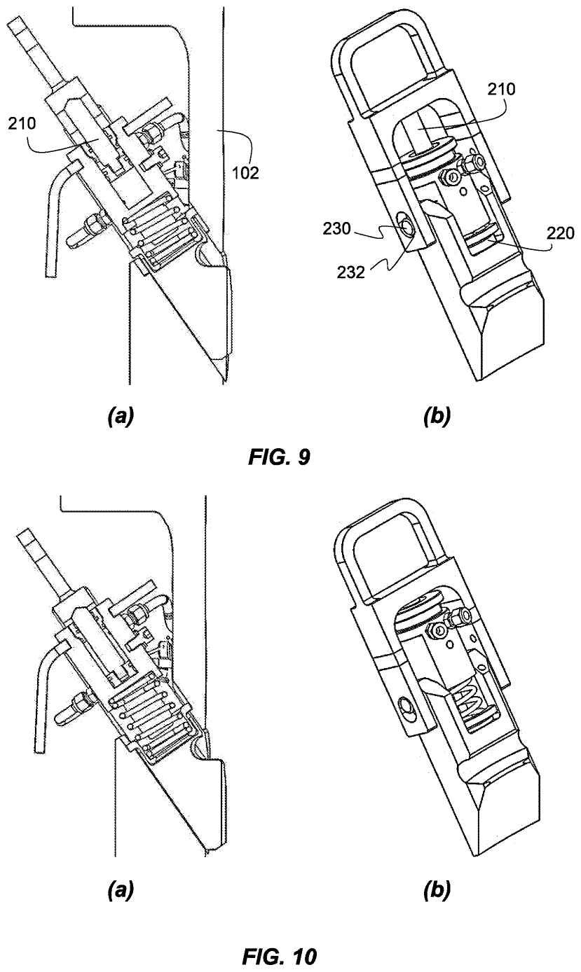

The function of the example embodiment of the latch mechanism 100 is now described with reference to FIGS. 9 to 11. During use (e.g. when disengaging the latch 206 from the male connector 300), actuator 208 is activated so as to move the piston rod 210 out of the pneumatic or hydraulic cylinder and push the link member 204 up. The upward moving link member 204 pulls the connected latch 206 into the aperture 108 and out of the central passage 104 against the biasing force provided by the coil spring 226. In this retracted position, the latch 206 is disengaged from the male connector 300. Upon deactivation of the pneumatic or hydraulic actuator 208, the biasing force provided by the coils spring 226 pushes the latch 206 back into the central passage 104 up to the point where the stop member 220 engages with the shoulder portions 218. At this point, the latch 206 is in an unbiased state protruding into the central passage 104 only far enough so as to allow the male connector 300 to engage with the seat portion 228 of the latch 206 when dropping down after release.

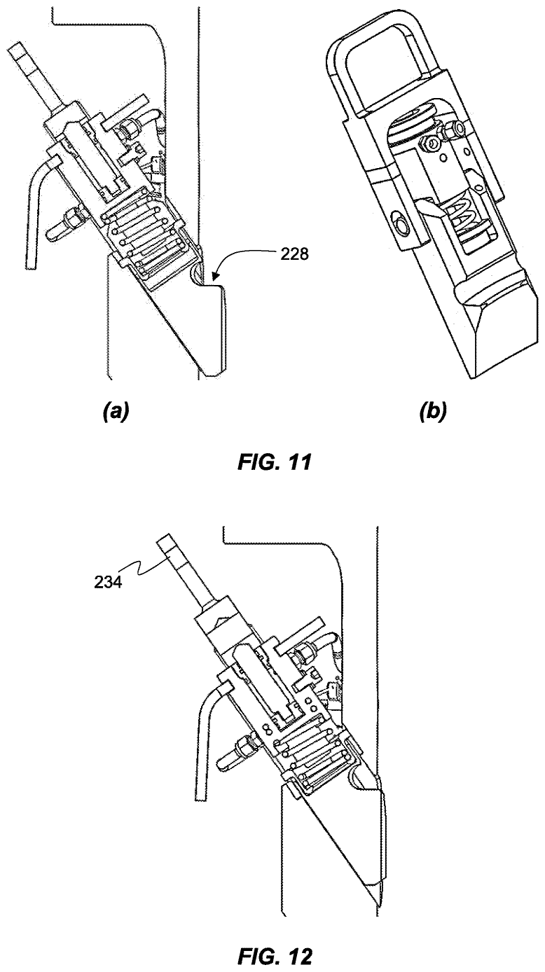

The stop member 220 prevents the spring 226 from pushing the latch 206 too far out into the central passage 104, as this could prevent the male connector 300 from properly engaging with the latch 206. Once the lip of the dropping male connector 300 has engaged with the seat portion 228, the weight of the male connector 300 pulls the latch 206 fully into the central passage 104 allowing the male connector 300 to fully engaged with the seat portion 228 of the latch 206. The unbiased axial movement of the latch 206 is limited to the length of the elongated apertures 232 of the link member 204 as shown in FIGS. 10(b) and 11(b).

Further, the latch 206 is adapted to move axially, as well as, rotationally with respect to the link member 204, thus, allowing the male connector 300 to centre itself within the central passage 104 of the female connector 100. Any movement of the engaged male connector 300 (e.g. tilting movement) within the central passage 104 is therefore compensated by the movable latch(es) 206, preventing or at least minimising unwanted friction between contact surfaces and reducing potential damage through excessive wear. Further, the compensating movement of the latch(es) 206 can reduce potentially harmful shear stresses caused by the moving male connector 300.

Also, the male connector 300 may be dimensioned such that the upper end has a smaller diameter than the lower end, i.e. the gap between the interior wall of the central passage 104 and the outer wall of the male connector 300 is larger at the top end than at the bottom end of the male connector 300. Thus, a tilting male connector 300 will contact the interior wall of the central passage 104 with its bottom end first allowing the latch(es) 206 to slide in and out the aperture(es) 108 to compensate.

In the event of an actuator failure, in order to release the engaged male connector 300 from the female connector 100, the latch 206 may also be retracted manually via a handle portion 234 provided at the proximal end of the link member 204 (see FIG. 12).

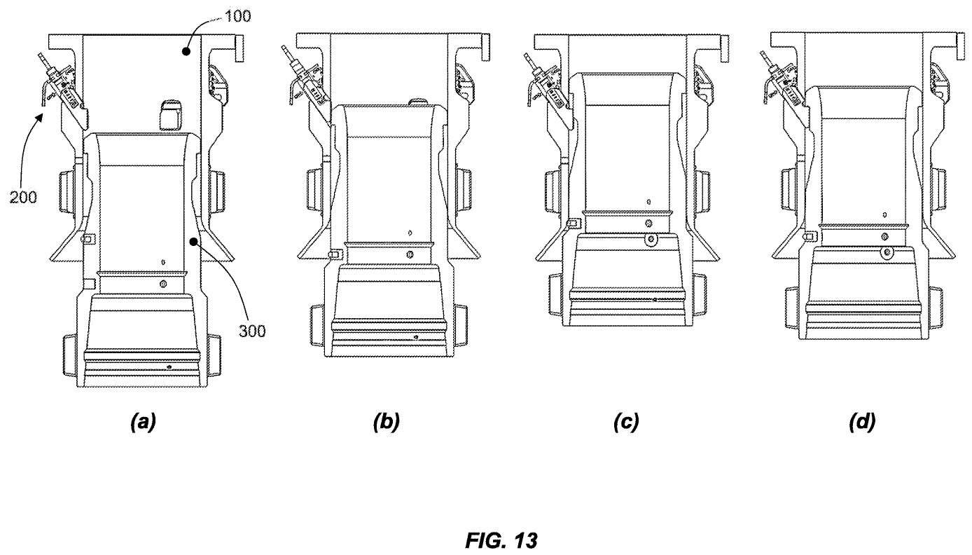

A sequence of the coupling procedure between the male connector 300 and female connector 100 is shown in FIGS. 13(a) to (d). Here, the male connector 300 is moved up and into the central passage 104 of the female connector 100. When moving up, the lip of the male connector 300 pushes the latch(es) 206 into the aperture 108 to allow the male connector 300 to move past the latch(es) 206 at which point the latch 206 is pushed back out of the aperture 108 by the spring 226. The male connector 300 is then dropped back down so that the lip engages with the seat portion 228 of the latch 206 and fully retracts the latch 206 into the central passage 104 and out of engagement with the spring 226.

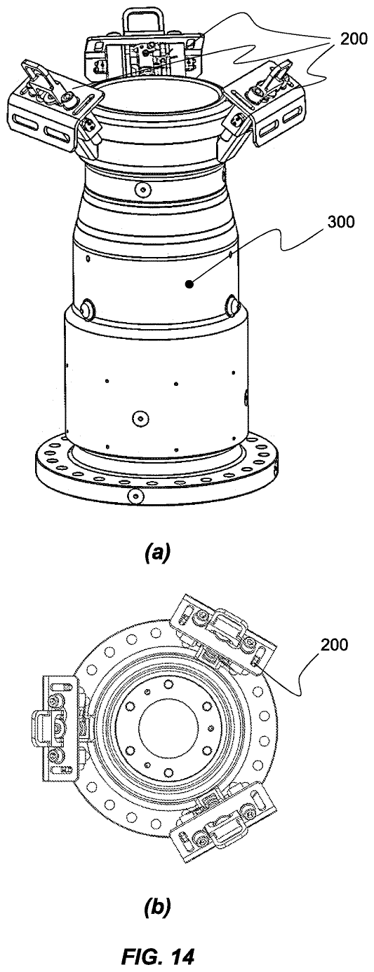

FIG. 14 shows a perspective side view and a top view of the male connector 300 and three engaged latch mechanisms 200, with the female connector 100 removed for illustration purposes.

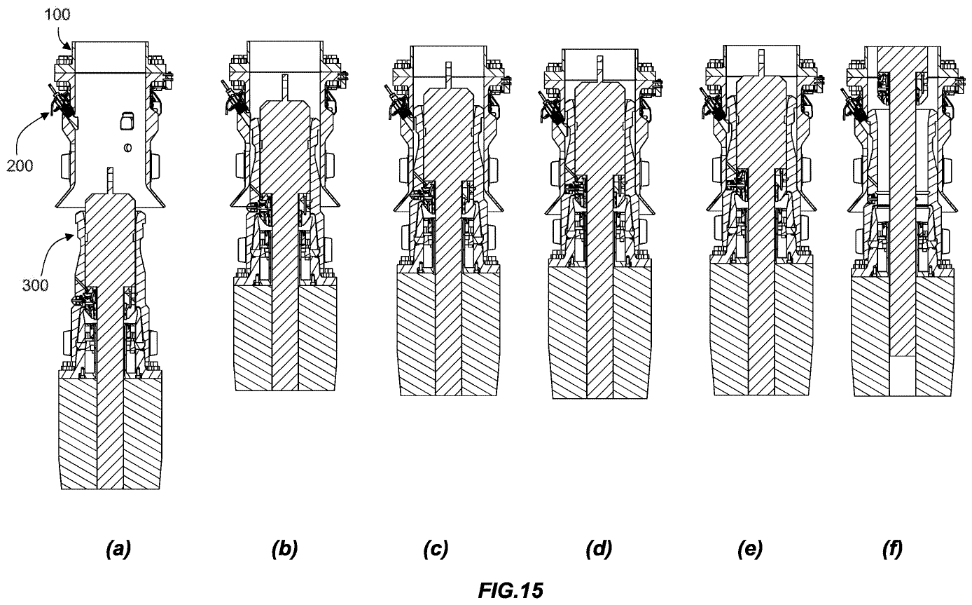

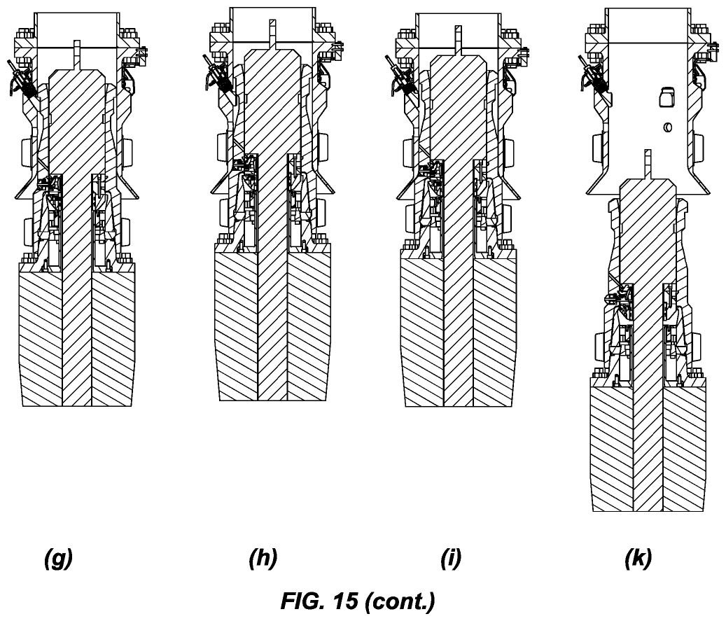

A full installation and deinstallation sequence of a bend stiffener mounted to a male connector 300 coupled with a string of tubulars pulled with a wire is illustrated in FIGS. 15(a) to (k). In particular, Figures (a) to (f) illustrated the coupling engagement between the male connector 300 and the female connector 100, wherein Figures (e) to (k) illustrate the decoupling of the male connector 300 from the female connector 100, i.e. moving the male connector 300 out of contact with the latches 206, activating the pneumatic or hydraulic actuator 208 to retract the latches 206 into apertures 108, moving the male connector 300 down and past the latch mechanism 200 and out of the central passage 104 of the female connector 100. In particular, the steps include (a) the Bend Stiffener Connector (BSC) (i.e. male connector 300 with attached bend stiffener) is pulled into the female connector 100 using the end-fitting with an attached wire or cable, (b) the upper shoulder of lip of the male connector 300 pushes past and thus forces the three latches 206 to retract into the aperture 108, (c) the upper shoulder of the male connector 300 moves past the top of the latches 206 and a release adapter of the end-fitting is activated so that the end-fitting starts to disengage from the male connector 300, (d) latches 206 spring back into the central passage 104 due to bias force caused by the compressed spring 226, and the lower male connector shoulder prevents further upward movement into the female connector 100 while the release adapter of the end-fitting is fully freed, (e) the end-fitting is pulled up and through the connector assembly into the ‘I’ tube, (f) the male connector 300 falls onto the protruding latches 206 pulling the latches further into the central passage 104 so as to centralise the position of the male connector 300 within the central passage 104, completing the installation. Steps for the disconnection of the BSC from engagement with the female connector 100 include (g) the end-fitting and release adapter are lowered so as to engage with the male connector 300, (h) the end-fitting and attached male connector 300 are lifted within the central passage until shoulder portion of the male connector 300 stoppingly engages with female connector 100, (i) the latches 206 are retracted, either via actuator 208 or manually, the actuator may be controlled remotely (e.g. from topside) or using an ROV hot stab system, and (k) the end-fitting and engaged male connector 300 with attached bend stiffener is lowered out of the female connector central passage 104 via cable or wire.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible, for example, variations may exist in shape, size, arrangement (i.e. a single unitary components or two separate components), assembly or the like. Also, any other suitable actuator mechanism (hydraulic, pneumatic, electric, magnetic etc.) may be used to move the latch 206 from a first position into a second retracted position.

Reference numerals list:

| | |
|---|---|
| 10 | Subsea well |
| 20 | FPSO |
| 30 | Flexible riser |
| 32 | End fitting |
| 40 | Turret |
| 50 | Bend stiffener |
| 60 | Fixed structure, ‘I’ or ‘J’ tube |
| 70 | Connector assembly (prior art) |
| 72 | Male connector (prior art) |
| 74 | Female connector (prior art) |
| 76 | Latch cam (prior art) |
| 78 | Clamp mechanism (prior art) |
| 80 | Wire line |
| 90 | Subsea divers |
| 92 | ROV |
| 100 | Female connector |
| 102 | Tubular body |
| 104 | Central passage |
| 106 | Central axis |
| 108 | Aperture/throughbore |
| 110 | Aperture axis |
| 112 | External wall of tubular body |
| 114 | Latch mount |
| 116 | Bolts |
| 200 | Latch mechanism |
| 202 | Latch mounting plate |
| 204 | Link member |
| 206 | Latch |
| 208 | Pneumatic/hydraulic Actuator |
| 210 | Piston rod |
| 212 | Pneumatic/hydraulic fluid lines |
| 214 | Manifold |
| 216 | Guide slots |
| 218 | Shoulder portion |
| 220 | Stop member |
| 222 | Rim portion |
| 224 | Cup portion |
| 226 | Coil spring |
| 228 | Seat portion |
| 230 | pins |
| 232 | Elongated pin aperture |
| 234 | Handle portion |

1. A female connector for a subsea connector assembly comprising a connector body, having a tubular wall forming a central passage along a central axis, and at least one latch mechanism, operably mounted into an aperture though said tubular wall along a wall axis aligned downward convergingly with said central axis, said latch mechanism comprising:
a latch member, coupled to a distal end portion of a link member so as to form a latch coupling that is configured to allow relative movement between said latch member and said link member in at least one first degree of freedom (DOF), said coupled latch and link member being arranged jointly slidably movably at least partially within said aperture and configured to move between a first position, where said latch member is at least partially extended into said central aperture, and a second position, where said latch member is retracted out of said central passage into said aperture;
an actuator, fixedly mounted to an outer surface of said tubular wall and operably coupled to said link member, configured to move said coupled latch and link member from said first position to said second position;
a biasing member, operably coupled between said connector body and said latch member, configured to biasingly engage said latch member towards said first position when moving between said first position and said second position, wherein said latch member is configured to disengage from said biasing member at said first position and move away unbiased from said first position to a third position into said central passage.

2. A female connector according to claim 1, wherein said latch coupling is formed by at least one elongated slot provided at said distal end portion of said link member and aligned parallel to said wall axis, and that is slidably and rotatably engaged with a respective latch projection, extending laterally away from said latch member along a lateral axis aligned perpendicular to said wall axis, when in situ.

3. A female connector according to claim 1, wherein said at least one first DOF is a sliding movement along said wall axis, when in situ.

4. A female connector according to claim 2, wherein said latch coupling is further configured to allow relative movement between said latch member and said link member in at least one second DOF.

5. A female connector according to claim 4, wherein said at least one second DOF is rotational movement about said lateral axis

6. A female connector according to claim 2, wherein said relative movement in said first DOF is limited to the slidable range of said latch projection within said elongated slot.

7. A female connector according to claim 6, wherein said third position is defined by a distal end of said elongated slot when said link member is in said second position.

8. A female connector according to claim 1, wherein said latch mechanism further comprises a stop member, provided between said biasing member and said latch member, arranged axially slidably within said aperture and adapted to stoppingly engage with an aperture shoulder portion.

9. A female connector according to claim 8, wherein said aperture shoulder portion is provided within said aperture such that said latch member disengages from said biasing member when at said first position.

10. A female connector according to claim 1, wherein said wall axis is aligned downward, when in situ, converging with said centre axis at an aperture angle in the range of 25 degrees to 45 degrees.

11. A female connector according to claim 1, wherein said aperture angle is 35 degrees.

12. A female connector according to claim 1, wherein said actuator is adapted to retain said coupled latch and link member in said second position.

13. A female connector according to claim 1, wherein said actuator is configured to be actuated remotely.

14. A female connector according to claim 1, wherein said latch member comprises a support portion at a distal end configured to stoppingly engage with a male connector.

15. A female connector according to claim 14, wherein said latch member comprises a contact surface at said distal end aligned substantially parallel to said central axis, when in situ, configured to contactingly engage with an outer surface of the male connector.

16. A female connector according to claim 1, comprising a plurality of latch mechanisms mounted circumferentially equidistantly about said central axis into respective coplanar apertures through said tubular wall.

17. A female connector according to claim 1, wherein said link member comprises a handle provided at a proximal end portion, configured to allow manual movement of said coupled latch and link member from said first position towards said second position.
